(19) United States
(12) Patent Application Publication
(10) Pub. No.: US 2007/0183724 A1
(43) Pub. Date: Aug. 9, 2007

(54) Optical connector, multi-chip module and manufacturing method of optical connector

(75) Inventor: Yasuhiro Sato, Ebina (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/546,413

(22) Filed: Oct. 12, 2006

(30) Foreign Application Priority Data
Feb. 7, 2006 (JP) 2006-030077

(51) Int. Cl. G02B 6/36

(52) U.S. Cl. 385/89; 385/88

(57) ABSTRACT

An optical connector includes an optical fiber and a connector. The latter includes: (i) an optical fiber insertion hole that an end portion of the optical fiber is inserted into; (ii) a front face that an end surface of the optical fiber inserted into the optical fiber insertion hole appears; and (iii) a window that allows light input and output and is positioned below the front face. The end surface of the optical fiber is formed as a reflection surface that is flush with the front face and reflects an optical signal coming via one of a light transmission route extending through the optical fiber insertion hole and a light transmission route perpendicular to the direction that the optical fiber insertion hole extends, toward the other.

### BACKGROUND

(i) Technical Field

The present invention relates to an optical connector connected with an optical fiber propagating an optical signal, a multi-chip module and a manufacturing method of the optical connector.

(ii) Related Art

As examples of conventional techniques in the field of electronics, there is known a so-called a multi-chip module which has a board provided with a photoelectric conversion device such as a laserdiode and a photodiode which converts one of an electric signal and an optical signal into the other. The board is also provided with an Integrated Circuit (IC) to drive the photoelectric conversion device.

Among multi-chip modules, there is one type of multi-chip module in which a photoelectric conversion device is disposed in such a manner that acting surfaces (surfaces for input or output of an optical signal) of the signal medium conversion device face upward while spreading in parallel with the surface of the multi-chip module. In this type of multi-chip module, by mounting thereon an optical connector connected with the optical fibers, it becomes possible to achieve an optical connection between the acting surfaces and the optical fibers which prevents an optical signal from deteriorating.

### SUMMARY

An optical connector according to one aspect of the present invention is an optical connector that includes:

an optical fiber; and

a connector that includes:
(i) an optical fiber insertion hole that an end portion of the optical fiber is inserted;
(ii) a front face that an end surface of the optical fiber inserted into the optical fiber insertion hole appears and that is tilted at about 45 degrees angle with respect to the direction that the optical fiber insertion hole extends; and
(iii) a window that allows light input and output and is positioned below the front face,

the end surface of the optical fiber inserted into the optical fiber insertion hole being formed as a reflection surface that is flush with the front face and reflects an optical signal coming via one of a light transmission route extending through the optical fiber insertion hole and a light transmission route perpendicular to the direction that the optical fiber insertion hole extends, toward the other.

### BRIEF DESCRIPTION OF THE DRAWINGS

Exemplary embodiments of the present invention will be described in detail based on the following figures, wherein:

FIG. 1 is an external perspective view of an optical connector, according to an exemplary embodiment of the invention;

FIG. 2 shows how the optical connector according to the exemplary embodiment is mounted on the multi-chip module;

FIG. 3 shows the manufacturing method of the optical connector according to an exemplary embodiment of the present invention; and

FIG. 4 shows the details of the processes shown in FIG. 3.

### DETAILED DESCRIPTION

Exemplary embodiments of the invention will be described below.

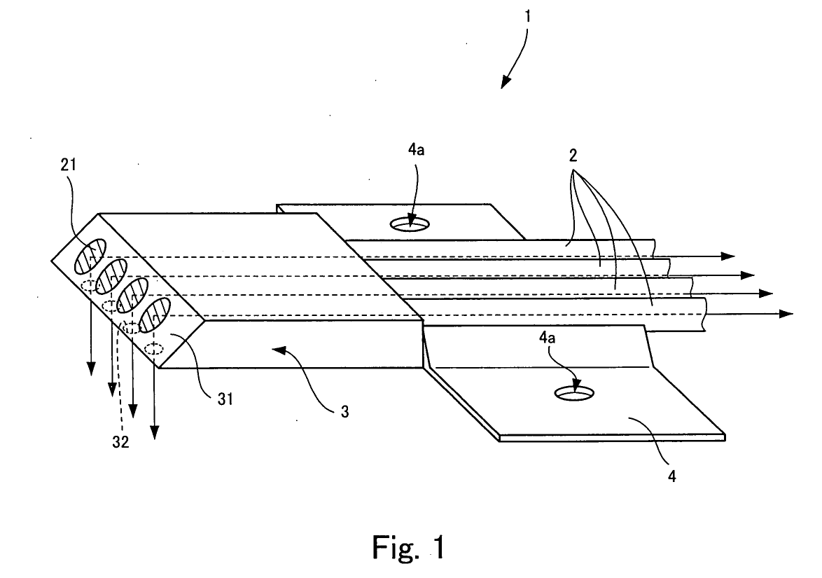

FIG. 1 is an external perspective view of an optical connector, according to an exemplary embodiment of the invention.

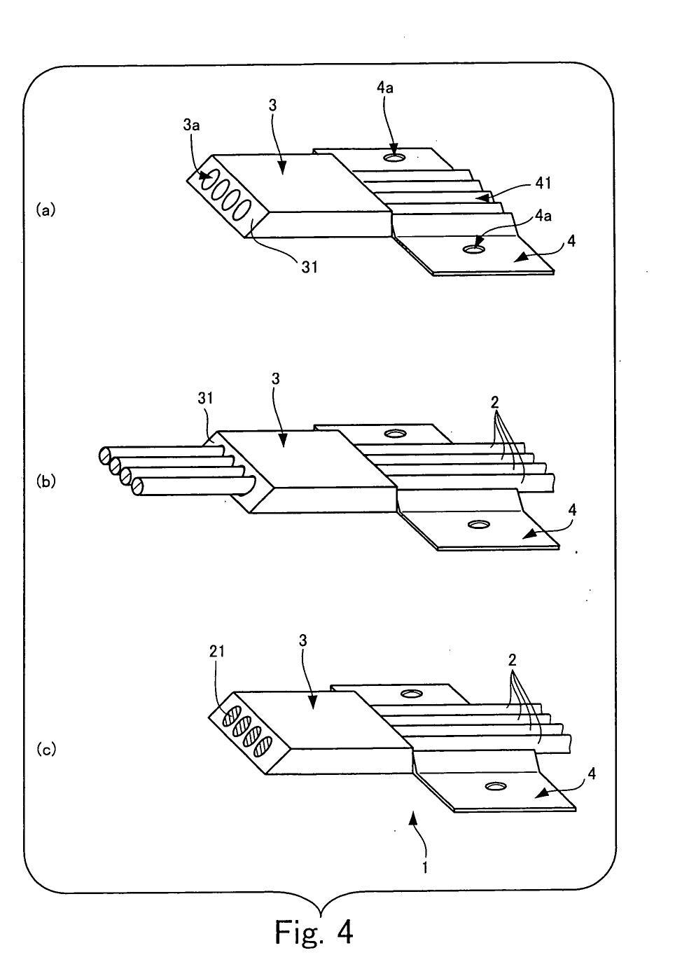

The optical connector 1 of the exemplary embodiment shown in FIG. 1 is an optical connector which is provided with a multi-chip module having a photoelectric conversion device such as a laserdiode and a photodiode converting one of an electric signal and an optical signal into the other, and which achieves an optical connection between the acting surfaces of the signal medium conversion device and optical fibers. The optical connector 1 includes four optical fibers 2, a connector section 3, and a guide section 4. The guide section 4 plays the role of positioning the optical connector 1. The connector section 3 has therein optical fiber insertion holes 3a (see FIG. 4) into which end portions of the core wires of the respective optical fibers 2 are inserted. The connector section 3 also has a front surface 31 on which end surfaces of the optical fibers 2 inserted into the optical fiber insertion holes 3a appear and which forms a 45 degrees angle with respect to the direction in which the optical fiber insertion holes 3a extend. In addition to the optical fiber insertion holes 3a and the front surface 31, the connector section 3 has windows 32 for light input and light output which are positioned below the front surface 31 tilted by a 45 degrees angle.

The end surfaces of the optical fibers 2 appearing on the front surface 31 have mirror surfaces 21 formed such that the mirror surfaces 21 become flush with the front surface 31. The mirror surfaces 21 each reflect an optical signal coming via one of a lateral light transmission route extending through the optical fiber insertion hole 3a and a vertical light transmission route perpendicular to the direction in which the optical fiber insertion hole 3a extends, toward the other. The former route is in the horizontal direction in FIG. 1 and the latter route is in the vertical direction in FIG. 1.

The guide section 4 shown in FIG. 1 is provided on the opposite side of the connector section 3 to the front surface 31 and includes guide holes 4a which guide the optical connector 1 when the optical connector 1 is mounted.

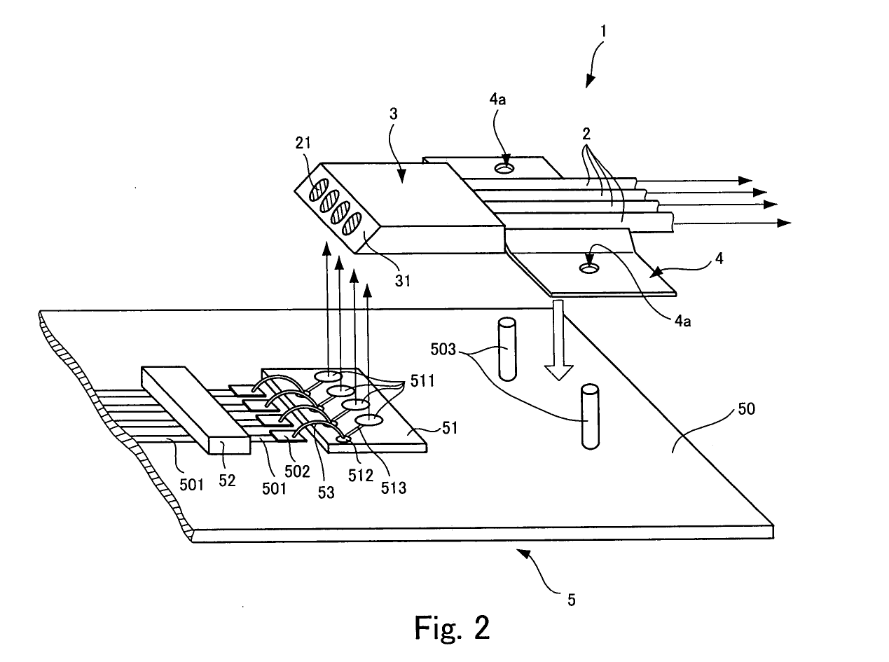

FIG. 2 shows how the optical connector 1 according to the exemplary embodiment is mounted on the multi-chip module.

As shown in FIG. 2, a laserdiode 51 whose acting surfaces face upward in this figure and a driver circuit 52 to drive the laserdiode 51 are provided on an electrical board 50, which consists in the multi-chip module 5 and on which electrical wires 501 are disposed. Solder pads 502 in the electrical wires 501 are electrically connected with electrodes 512 of the laserdiode 51 by bond wires 53.

FIG. 2 also shows guide pins 503 standing at the positions on the electrical board 50 which corresponds to the positions of the guide holes 4a of the guide section 4 in the optical connector 1. The optical connector 1 shown in the upper part of FIG. 2 is mounted on the multi-chip module 5 by inserting the guide bars 503 into the guide holes 4a. As a result, there is realized light transmission in which an optical signal coming from the acting surfaces 511 of the laserdiode 51 is incident on the optical connector 1 through the windows 32 formed for light input and light output at the bottom of the optical connector 1, and is reflected at an angle of 90 degrees by the mirror surfaces 21 of the optical fibers 2, traveling through the optical fibers 2 inserted into the optical fiber insertion holes 3a.

According to the optical connector 1 of the exemplary embodiment of the present invention, it is possible to realize optical connection between the acting surfaces 511 of the laserdiode 51 and the optical fibers 2 with a simple structure.

Next, a manufacturing method of the optical connector shown in FIG. 1 will be described.

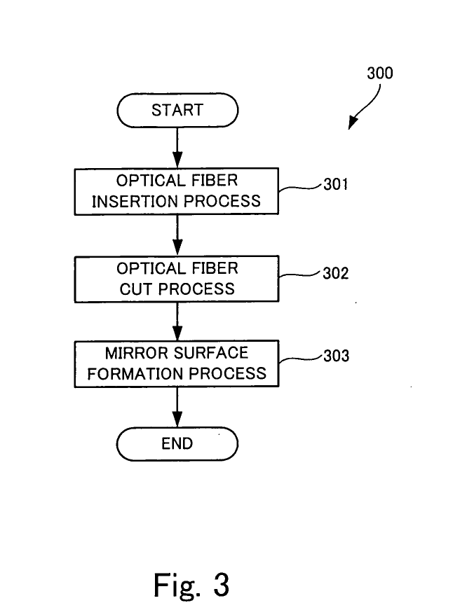

FIG. 3 shows the manufacturing method of the optical connector according to an exemplary embodiment of the present invention. The following description will be made with reference to FIG. 4 in addition to FIG. 3.

As shown in FIG. 3, the manufacturing method of the optical connector in this exemplary embodiment includes an optical fiber insertion process 301, an optical fiber cut process 302 and a mirror surface formation process 303. The optical fiber insertion process 301 is a process in which the end portions of the core wires of the optical fibers 2 are inserted into the optical fiber insertion holes 3a of the connector section 3 (see FIG. 4) in such a manner that the optical fibers 2 stick out of the front surface 31 in the connector section 3. The optical fiber cut process 302 is a process in which the portions of the optical fibers 2 sticking out of the front surface 31 in the connector section 3 are cut in order that the end surfaces of the optical fibers 2 becomes flush with the front surface 31. The mirror surface formation process 303 is a process in which the mirror surfaces 21 are formed in the end surfaces of the optical fibers 2.

FIG. 4 shows the details of the processes shown in FIG. 3.

Part (a) of FIG. 4 shows the connector section 3 and the guide section 4 before the end portions of the optical fibers 2 are inserted, and as shown in this figure, the guide section 4 has holding grooves 41 to hold four optical fibers.

Part (b) of FIG. 4 shows the end portions of the optical fibers 2 that are inserted into the optical fiber insertion holes 3a of the connector section 3 in such a manner that the optical fibers 2 stick out of the front surface 31.

Part (c) of FIG. 4 shows the mirror surfaces 21 formed by polishing the end surfaces of the optical fibers 2 after the portions of the optical fibers 2 sticking out of the front surface 31 are cut in order that the end surfaces of the optical fibers 2 become flush with the front surface 31.

Incidentally, the above exemplary embodiment employs, as an example, polishing the end surfaces of the optical fibers 2 in order to form the mirror surfaces 21. However, the present invention is not limited to this and the exemplary embodiments described above may employ deposition in order to form the mirror surfaces 21. Also, the windows 32 for light input and light output employed in exemplary embodiments described above may be openings which are large enough for an optical signal to run there through without loss, or may be transparent plates through which an optical signal can run without loss.

What is claimed is:

1. An optical connector comprising:
an optical fiber; and
a connector that includes:
(i) an optical fiber insertion hole that an end portion of the optical fiber is inserted into;
(ii) a front face that an end surface of the optical fiber inserted into the optical fiber insertion hole appears and that is tilted at about 45 degrees angle with respect to the direction that the optical fiber insertion hole extends; and
(iii) a window that allows light input and output and is positioned below the front face,
the end surface of the optical fiber inserted into the optical fiber insertion hole being formed as a reflection surface that is flush with the front face and reflects an optical signal coming via one of a light transmission route extending through the optical fiber insertion hole and a light transmission route perpendicular to the direction that the optical fiber insertion hole extends, toward the other.

2. The optical connector according to claim 1, wherein the connector further includes a guide unit on the side opposite to the front face and defines a guide hole.

3. A manufacturing method of an optical connector, comprising:
inserting an end portion of an optical fiber into an optical fiber insertion hole of a connector in such a manner that the end portion of the optical fiber sticks out of a front face of the connector, an end surface of the end portion of the optical fiber inserted into the optical fiber insertion hole appearing on the front face of the connector, and the front face of the connector being tilted at about 45 degrees angle with respect to the direction that the optical fiber insertion hole extends, the connector having a window that allows light input and output and is positioned below the front face;
cutting the end portion of the optical fiber sticking out of the front face so that the end surface of the end portion of the optical fiber becomes flush with the front face; and
forming the end surface of the optical fiber inserted into the optical fiber insertion hole as a mirror surface that is a reflection surface made flush with the front face and reflects an optical signal coming via one of a light transmission route extending through the optical fiber insertion hole and a light transmission route perpendicular to the direction that the optical fiber insertion hole extends, toward the other.

4. A multi-chip module comprising:
a board and an optical connector, the optical connector including: an optical fiber; and
a connector that includes:
(i) an optical fiber insertion hole that an end portion of the optical fiber is inserted into;
(ii) a front face that an end surface of the optical fiber inserted into the optical fiber insertion hole appears and that is tilted at about 45 degrees angle with respect to the direction that the optical fiber insertion hole extends; and
(iii) a window that allows light input and output and is positioned below the front face,
a guide unit that defines a guide hole on the side opposite to the front face;
the end surface of the optical fiber inserted into the optical fiber insertion hole being formed as a reflection surface that is flush with the front face and reflects an optical signal coming via one of a light transmission route extending through the optical fiber insertion hole and a light transmission route perpendicular to the direction that the optical fiber insertion hole extends, toward the other,
the optical signal coming into the connector from the window, and being reflected on the reflection surface at about 90 degrees, and going to the direction that the optical fiber insertion hole extends.
